(19) United States
(12) Patent Application Publication
(10) Pub. No.: US 2020/0041450 A1
(43) Pub. Date: Feb. 6, 2020

(54) METHOD FOR IDENTIFYING ZETA POTENTIALS OF NANOPORES AND NANOPARTICLES

(71) Applicant: NATIONAL YUNLIN UNIVERSITY OF SCIENCE AND TECHNOLOGY, DOULIOU CITY (TW)

(72) Inventors: LI-HSIEN YEH, DOULIOU CITY (TW); YEN-SHAO SU, DOULIOU CITY (TW); CHUN-HSIANG WANG, DOULIOU CITY (TW); TZUNG-HAN CHOU, DOULIOU CITY (TW)

(21) Appl. No.: 16/052,619

(22) Filed: Aug. 2, 2018

(51) Int. Cl. G01N 27/447

(52) U.S. Cl. CPC G01N 27/44791

(57) ABSTRACT

A method for detecting the zeta potentials of nanopores and nanoparticles mainly uses an electrokinetic mechanism with a force balance exerted on particles in a nanopore and a current sensing technology to measure the zeta potential of the nanopore accurately, and then uses the measured zeta potential of the pore to further measure the zeta potential of the electrically charged nanoparticle passing through the pore. This method does not need to analyze the detailed spectrum of the current blockage signals and purchase expensive standard item particles, so that this method has high accuracy and less limitation than the conventional method and achieves the effects of simplifying the measurement process and lowering the measurement cost significantly. For soft nanoparticles, this method can sense the zeta potential of particles more accurately to improve the value of the method of this invention.

### FIELD OF INVENTION

The present invention relates to the field of nano analyzing devices, in particular to a method for identifying the zeta potentials of nanopores and nanoparticles.

### BACKGROUND OF INVENTION

### 1. Description of the Related Art

As nanotechnology has been developed rapidly and applied extensively in various fields, and the nano construction technique advances, the application of nanofluidic devices attracts the attention of international research groups in recent years. Typical applications include laboratory chips used for analyzing biomolecules, sensors capable of identifying ions/molecules, and nano energy conversion devices capable of converting green energy . . . etc. Among these nanofluidic devices, the application of conical nanopores and cylindrical nanopores is very popular. The applications of those nanofluidic devices depend substaneously on the interfacial charge property of the pore, which can be affected directly by the electrolyte concentration and the pH value in the solution, or indirectly by the surface modification of the pore wall. Therefore, if one can analyze the zeta potential of the nanopore using a current change sensor of the nanopore analytical technology, then it will be able to understand the phenomena occurred in the nanopore much better to promote related applications of the nanofluidic devices.

In recent years, the nanofluidic devices have been constantly expanded to investigate and analyze soft living organisms, and these studies include various analytes such as nucleic acids, proteins, and viruses. Therefore, an analytical technique of controlling a single particle entering into a pore is evolved, and this technique is capable of analyzing the size of single unlabeled sensing particles in a wide range of a micron scale to a molecular scale by calibrating with the standard items of analytes. In addition, the stability of the suspension solution of nanoparticles is profoundly affected by the zeta potential of particles in contact with an aqueous solution. The current measuring tools for analyzing the zeta potential of nanoparticles are generally based on the principle of the dynamic light scattering (DLS) technique together with electrophoresis, and such technical principle requires an application of a potential bias to both electrodes in a sample cell to drive the electrophoresis of particles. If there is a high-salt electrolyte solution (such as a physiological environment) occurred during the measurement of the zeatzeta potential of particles, then ions in the solution will spontaneously have an oxidation reaction with the electrodes in the electrode slot, and such violent reaction not just affects the measuring results of the zeta potential of particles only, but also remarkably shortens the life of the electrodes.

In addition, U.S. Pat. Application No. 2016/0223492 has disclosed a method for measuring the surface charge of particles, and this method requires a standard iterm with the known particle surface charges and with the particle size substantially equal to the particle size of the substance to be measured, and then uses the standard item and the time difference ratio of a current change signal generated by passing the substance to be measured through the nanopore to derive the zeta potential of the substance to be measured. Firstly, regardless of this method that requires the assumption of the identical current blockage signal changes when the above two particles with the same sizes pass through the nanopore, this method still has the following four drawbacks. 1. The inventor of the present invention has provided both the experimental and theoretical results as published in the article (ACS NANO, 2016, 10, 8413-8422) to show that the surface charge (or zeta potential) of particles will affect the height of the largest current blockage signal and the passing time difference, but this U.S. Patent publication believes that the surface charge (or zeta potential) of particles just affects only the time difference of the current blockage signal caused by the passage of particles. The above assumption results in the measured value of particles' surface charge being not matched with the actual value; in general, the greater the surface charge of particles, the greater the deviation. 2. This measuring method requires a specific number of particles (usually more than 200) to pass through the pore in order to generate the sufficient current blockage signals. If a large number of particles pass through the pore, the pore will be blocked easily. 3. This measuring method requires the detailed spectrum of the current blockage signals of the particles passing through the pore, but many literatures have already shown that the detailed spectrum of the current blockage signals will be severely affected by many system variables (such as the applied voltage, the geometric shape of pores and particles, the electrolyte concentration, and the pH value of the solution), especially when a number of particles pass through the pore, causing a misjudgment of the zeta potential of particles. 4. This measuring method requires a standard item with a particle size and a geometric shape substantially the same as those of the substance to be measured, so that the appropriate standard item must be found and prepared before each measurement, and therefore the execution of the method is very inconvenient. In addition, these standard items are very expensive.

In view of the aforementioned drawbacks of the prior art, the inventor of the present invention based on years of experience in the related industry to conduct extensive research and development, and finally provided a method for detecting the zeta potential of nanopores and nanoparticles to overcome the drawbacks of the prior art.

### 2. Summary of the Invention

Therefore, it is a primary objective of the present invention to overcome the aforementioned drawbacks of the prior art by providing a method for detecting the zeta potential of nanopores and nanoparticles, and the method is based on the electrokinetic mechanism with a force balance exerted on the particles in a nanopore and a current sensing technology to detect and measure the zeta potential accurately without requiring the use of standard item particles or analyzing the detailed spectrum of the current blockage signals.

To achieve the aforementioned and other objectives, the present invention provides a method for detecting the zeta potential of nanopores, and the method comprises the steps of: preparing at least a dispersed-phase suspension of uncharged particles and placing the uncharged particle at an upper reservoir at a position outside a first opening of a nanopore; applying a positive potential bias (V>0) to a lower reservoir disposed at a second opening of the nanopore, wherein the uncharged particle is neutral, so that the uncharged particle just receives a reverse electroosmotic force (reverse EOF) provided by a negatively charged nanopore due to the positive potential bias, so that the uncharged particle cannot enter into the nanopore; applying a positive pressure field (ΔP>0) to the uncharged particle, so that the uncharged particle receives a positive pressure, and slowly increasing the positive pressure field, so that when the positive pressure is approximately equal to the reverse electroosmotic force, the uncharged particle will move towards the interior of the nanopore, and now the measured value of the positive pressure is a critical pressure value; calculating a critical pressure flow by the critical pressure value and a local electric field in the pore by the value of the positive potential bias; and substituting all calculated values into the equation of ζ_{NP}=−(μQₚ₁)/(εEA) to calculate the zeta potential of the nanopore, where ζ_{NP} is the zeta potential of the nanopore, μ is the viscosity of the solution, ε is the dielectric constant of the solution, Qₚ₁ is the critical pressure flow, E is the local electric field in the pore, and A is the area of the first opening of the nanopore.

In addition, this invention also provides a method for detecting the zeta potential of positively charged nanopores, and the method comprises the steps of: preparing at least a dispersed-phase suspension of uncharged particles, and placing the uncharged particle into an upper reservoir disposed at the first opening of a nanopore; after applying a negative potential bias (V<0) to a lower reservoir disposed at the second opening of the nanopore, the uncharged particle is neutral, so that the uncharged particle just receives a reverse electroosmotic force (reverse EOF) provided by the positively charged nanopore due to the negative potential bias, so that the uncharged particle cannot enter into the nanopore; applying a positive pressure field (ΔP>0) to the uncharged particle, so that the uncharged particle receives a positive pressure, and slowly increasing the positive pressure field, so that when the positive pressure is approximately equal to the reverse electroosmotic force, the uncharged particle will move towards the interior of the nanopore, and now, the measured value of the positive pressure is a critical pressure value; calculating a critical pressure flow by the critical pressure value and a local electric field in the pore by the value of the negative potential bias; and substituting all calculated values into the equation of ζ_{NP}=−(μQₚ₁)/(εEA) to calculate the zeta potential of the nanopore, where ζ_{NP} is the zeta potential of the nanopore, μ is the viscosity of the solution, E is the dielectric constant of the solution, Qₚ₁ is the critical pressure flow, E is the local electric field in the pore, and A is the area of the first opening of the nanopore.

Wherein, the critical pressure flow of the aforementioned two methods is calculated by the following equation:

$${Q}_{p 1} = \frac{Δ {P}_{c 1}}{[ \frac{8 μ d ( \frac{1}{{a}^{3}} - \frac{1}{{b}^{3}} )}{3 π ( b - a )} + 1.5 μ ( \frac{1}{{a}^{3}} + \frac{1}{{b}^{3}} ) ]} ,$$

Where, ΔP_{c1} is the critical positive pressure, a is the first opening diameter of the nanopore, b is the second opening diameter of the nanopore, and d is the length of the nanopore.

The local electric field in the pore is calculated by

$$E = \frac{V ( ab )}{[ d + 0.8 ( a + b ) ] {a}^{2}} ,$$

where V is the applied potential bias. In addition the second opening diameter of the nanopore may be measured by a high-resolution optical microscope (or a scanning electron microscope), the length of the nanopore may be measured by a laser confocal microscope (or a scanning electron microscope), and the first opening diameter of the nanopore may be calculated by a=(4dI₀)/(πΛVb), where Λ is the electric conductivity of the electrolyte solution, and I₀ is the background ionic current of the nanopore measured in an electrolyte solution condition.

The present invention further provides a method for detecting the zeta potential of negatively charged nanoparticles by using the aforementioned method of detecting the zeta potential of the nanopore, and this method comprises the steps of: preparing a dispersed-phase suspension of negatively charged nanoparticles in an electrolyte solution environment, and placing the nanoparticle into an upper reservoir disposed at the first opening of the nanopore; applying a positive potential bias (V>0) to a lower reservoir disposed at the second opening of the nanopore, wherein the nanoparticle is negatively charged, so that the nanoparticle will receive a forward electrophoretic force and a reverse electroosmotic force provided the negatively charged nanopore due to the positive potential bias, and the forward electrophoretic force is greater than the reverse electroosmotic force, so that the nanoparticle will move towards the interior of the nanopore; applying a negative pressure field to the nanoparticle, so that the nanoparticle receives a reverse pressure action force, and slowly increasing the negative pressure field, so that when the reverse pressure action force plus the reverse electroosmotic force is approximately equal to the forward electrophoretic force, the nanoparticle will stop moving towards the interior of the nanopore, and the measured value of the reverse pressure action force is now a critical negative pressure value; calculating a critical negative pressure flow by the critical negative pressure value; and substituting all calculated values into the equation of

$$0 = - [ \frac{ɛ ( {ζ}_{p} - {ζ}_{NP} ) E}{μ} ] + \frac{{Q}_{p 2}}{A}$$

to obtain the zeta potential of the nanoparticle, where ζₚ is the zeta potential of the nanoparticle, ζ_{NP} is the zeta potential of the nanopore, μ is the viscosity of the solution, ε is the dielectric constant of the solution, Qₚ₂ is the critical negative pressure flow, E is the local electric field in the pore, and A is the area of the first opening of the nanopore.

The critical negative pressure flow is calculated by

$${Q}_{p 2} = \frac{Δ {P}_{c 2}}{[ \frac{8 μ d ( \frac{1}{{a}^{3}} - \frac{1}{{b}^{3}} )}{3 π ( b - a )} + 1.5 μ ( \frac{1}{{a}^{3}} + \frac{1}{{b}^{3}} ) ]} ,$$

where ΔP_{c2} is the critical negative pressure value.

If the geometric shape of the nanopores and the applied positive potential bias used for measuring the zeta potentials of nanopores and nanoparticles are the same, or the first opening diameter, second opening diameter, pore length, and local electric field in the nanopore used for measuring the two zeta potentials are the same, then the zeta potential of nanoparticles can also be calculated by

$$\frac{{ζ}_{NP} - {ζ}_{P}}{{ζ}_{NP}} = \frac{Δ {P}_{c 2}}{Δ {P}_{c 1}} ,$$

where ζₚ is the zeta potential of the nanoparticles, ζ_{NP} is the zeta potential of the nanopores, ΔP_{c2} is the critical negative pressure value, and ΔP_{c1} is the critical positive pressure value.

In addition, the present invention further provides a method for detecting the zeta potential of positively charged nanoparticles by the method of detecting the zeta potential of nanopores, and this method comprises the steps of: preparing at least a dispersed-phase suspension of positively charged nanoparticles, and placing the nanoparticle into a reservoir outside the first opening of a nanopore; applying a negative potential bias (V<0) to the nanopore, wherein the nanoparticle is positively charged, so that the nanoparticle will receive a forward electrophoretic force and a forward electroosmotic force provided by a negatively charged nanopore due to the negative potential bias, and the resultant force of the two forces is forward, so that the nanoparticle will move towards the interior of the nanopore and the system current value has an obvious current signal change produced by the particles passing through the pore; applying a negative pressure field to the nanoparticle, so that the nanoparticle receives a reverse pressure action force, and slowly increasing the negative pressure field, so that when the reverse pressure action force is approximately equal to the resultant force of the forward electrophoretic force and the forward electroosmotic force, the positively charged nanoparticle will stop moving towards the interior of the nanopore, and the previous current change signal generated by the nanoparticle passing through the pore will not show up, and the measured value of the reverse pressure action force is now a critical negative pressure value; calculating a critical negative pressure flow by the critical negative pressure value; and substituting all calculated values into the equation of

$$0 = - [ \frac{ɛ ( {ζ}_{p} - {ζ}_{NP} ) E}{μ} ] + \frac{{Q}_{p 3}}{A}$$

to obtain the zeta potential of the positively charged nanoparticle, where ζₚ is the zeta potential of the positively charged nanoparticle, ζ_{NP} is the zeta potential of the nanopore, μ is the viscosity of the solution, ε is the dielectric constant of the solution, Qₚ₃ is the critical negative pressure flow, E is the local electric field in the pore, and A is the area of the first opening of the nanopore.

The critical negative pressure flow is calculated by

$${Q}_{p 3} = \frac{Δ {P}_{c 3}}{[ \frac{8 μ d ( \frac{1}{{a}^{3}} - \frac{1}{{b}^{3}} )}{3 π ( b - a )} + 1.5 μ ( \frac{1}{{a}^{3}} + \frac{1}{{b}^{3}} ) ]} ,$$

where ΔP_{c3} is the critical negative pressure value.

If the geometric shape of the nanopores and the applied negative potential bias used for measuring the zeta potentials of nanopores and positively charged nanoparticles are the same, or the first opening diameter, second opening diameter, pore length, and local electric field in the nanopore used for measuring the two zeta potentials are the same, the zeta potential of nanoparticles may be calculated by

$$- ( \frac{{ζ}_{NP} - {ζ}_{P}}{{ζ}_{NP}} ) = \frac{Δ {P}_{c 3}}{Δ {P}_{c 1}} ,$$

where ζₚ is the zeta potential of positively charged nanoparticles, ζ_{NP} is the zeta potential of the nanopore, ΔP_{c3} is the critical negative pressure value, and ΔP_{c1} is the critical positive pressure value.

With the method of the present invention, the zeta potential of nanopores can be measured accurately by using the force balance of an electrokinetic mechanism of the particles in the nanopore, and the zeta potential of charged nanoparticles can further be measured by the measured zeta potential of the pore, and the method of this invention does not require a detailed spectrum of the current blockage signals or the need of purchasing expensive standard item particles, so as to simplify the measurement process and lower the measurement cost significantly. In addition, as to the soft nanoparticles, the zeta potential of the particles can be measured more accurately to improve the value of the method of this invention.

### BRIEF DESCRIPTION OF THE DRAWINGS

FIG. 1A shows the force exertion of uncharged particles and negatively charged pores after a positive potential bias is applied in an experiment for detecting the zeta potential of nanopores;

FIG. 1B shows another implementation mode of the force exertion of uncharged particles and negatively charged pores after a positive potential bias is applied in an experiment for detecting the zeta potential of nanopores;

FIG. 2A shows the force exertion of uncharged particles and negatively charged pores after a positive potential bias field and a positive pressure field are applied in an experiment for detecting the zeta potential of nanopores;

FIG. 2B shows another implementation mode of the force exertion of uncharged particles and negatively charged pores after a positive potential bias field and a positive pressure field are applied in an experiment for detecting the zeta potential of nanopores;

FIG. 3 shows the current signals for analyzing the change of the zeta potential of a nanopore in electrolyte solutions of various concentrations;

FIG. 4 lists the data of the smallest exertion values of the critical positive pressure on a nanopore required by uncharged particles in electrolyte solutions of various concentrations;

FIG. 5 is a curve showing the zeta potential of a nanopore varying with various electrolyte solution concentrations;

FIG. 6 lists the current signals for analyzing the change of the zeta potential of a nanopore in solutions of various pH values;

FIG. 7 lists the smallest exertion values of the critical positive pressure value on a nanopore required by the uncharged particles in solutions of various pH values;

FIG. 8 is a graph showing the zeta potential of a nanopore varying with the pH value of the electrolyte solution;

FIG. 9A is a schematic view showing the particle receiving forces and the pore in an experiment of detecting the zeta potential of nanoparticles after a positive potential bias is applied;

FIG. 9B is a schematic view showing another implementation mode of the particle receiving forces and the pore in an experiment of detecting the zeta potential of nanoparticles after a positive potential bias is applied;

FIG. 10A is a schematic view of the particle receiving forces and the pore during an experiment of detecting the zeta potential of nanoparticles after a positive potential bias and a negative pressure field are applied;

FIG. 10B is a schematic view of another implementation mode of the particle receiving forces and the pore during an experiment of detecting the zeta potential of nanoparticles after a positive potential bias and a negative pressure field are applied

FIG. 11 is a schematic view showing the current signals for analyzing the change of the zeta potential of nanoparticles in electrolyte solutions of various concentrations;

FIG. 12 lists the data of the smallest exertion values of the critical negative pressure required by charged nanoparticles in electrolyte solutions of various concentrations;

FIG. 13 is graph showing the zeta potential of nanoparticles varying with various electrolyte solution concentrations;

FIG. 14 is a schematic view showing the current signals for analyzing the change of the zeta potential of nanoparticles in electrolyte solutions of various pH values;

FIG. 15 lists the data of the smallest exertion values of the critical negative pressure required by charged nanoparticles in electrolyte solutions of various pH values; and

FIG. 16 is a graph showing the zeta potential of nanoparticles varying with various pH values of the solution.

### DESCRIPTION OF THE PREFERRED EMBODIMENTS

The above and other objects, features and advantages of this disclosure will become apparent from the following detailed description taken with the accompanying drawings. It is noteworthy that same numerals are used for the same respective elements in the drawing.

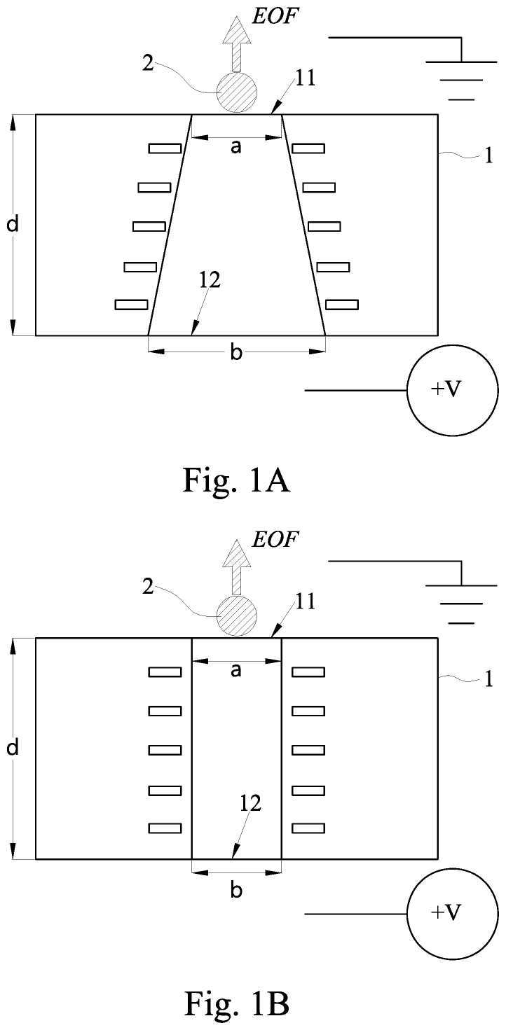

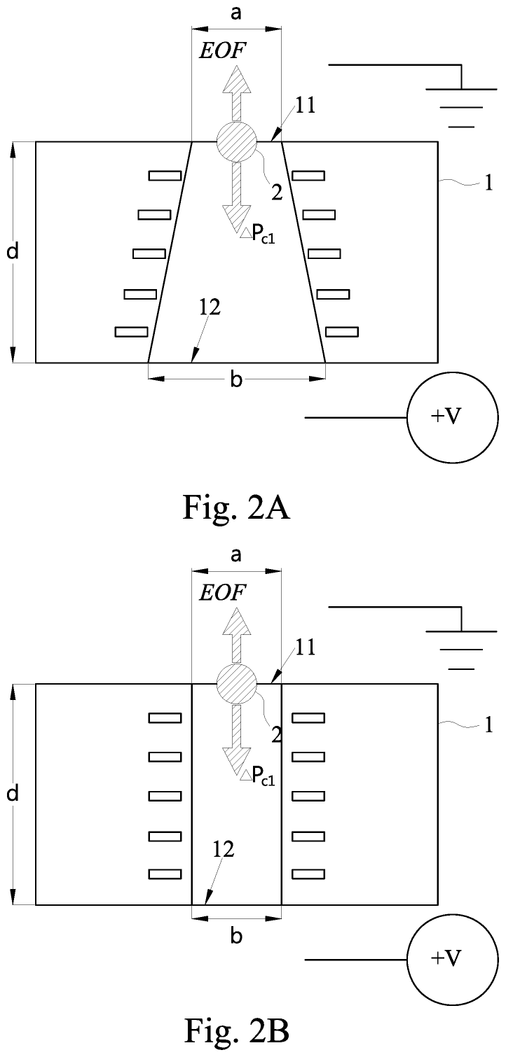

With reference to FIGS. 1A and 2A for a schematic view of particles and a pore after applying an applied positive potential bias to detect the zeta potential of the nanopore and a schematic view of the particles receiving the forces after the applied positive potential bias and a positive pressure field of the pore are applied respectively, the shape of the nanopore 1 used in this invention is in a frusto conical shape, but the invention is not limited to such shape only, and it the nanopore 1 may also be in a cylindrical shape as shown in FIGS. 1B and 2B.

Both ends of the nanopore 1 have a first opening 11 and a second opening 12 respectively, and an open area of the first opening 11 is smaller than that of the second opening 12, and the second opening diameter b of the nanopore 1 can be measured by a high-resolution optical microscope or a scanning electron microscope, and the length d of the nanopore 1 can be measured by a laser confocal microscope or a scanning electron microscope, and the first opening diameter a of the nanopore 1 can be calculated by a=(4dI₀)/(πΛVb), where, Λ is the electric conductivity of the electrolyte solution, V is the applied positive potential bias, I₀ is the background value of ionic current when the positive potential bias is applied to the nanopore in the electrolyte solution condition. In addition, the method for detecting the zeta potential of the nanopore 1 in accordance with the present invention is analyzed based on an electrokinetic mechanism of the resultant force of particles in the pore. In other words, an electric field is applied to the electrically charged nanoparticles and a pressure field is provided for driving the particles to receive the following three action forces when the particles pass through the first opening 11 of the conical nanopore 1 through its own speed, wherein the three action forces are electrophoretic force (EP), electroosmotic force (EOF), and pressure force (ΔP). Therefore, we can obtain the following equation:

$$\frac{J}{C} = - [ \frac{ɛ ( {ζ}_{p} - {ζ}_{NP} ) E}{μ} ] + \frac{{Q}_{p}}{A} \qquad ( 1 )$$

In the equation above, J is the molar flux of nanoparticles passing through the nanopore, C is the molar concentration of the nanoparticle dispersed-phase solution, ε is the dielectric constant of the solution, ζₚ is the zeta potential of the nanoparticle, ζ_{NP} is the zeta potential of the nanopore, μ is the viscosity of the solution, E is the local electric field in the pore, Qₚ is a fluid volume flow in the pore caused by an additional pressure field, A (=πa²) is the cross-sectional area of the first opening 11 of the nanopore 1. The first to third items from the right side of Equation (1) are three driving forces: electrophoretic force, electroosmotic force, and pressure force received by the nanoparticles in the pore.

When the zeta potential of the nanopore 1 is measured, at least an electrically uncharged nanoparticle 2 is prepared, and the preparation method firstly dissolves hydrogen phosphatidylcholine and polyoxyethylene (40) stearate in a chloroform-methanol (v/v %=1/1) solvent with an amount of 2 ml of molar ratio 9:1 added into a round-bottom flask in a thermostatic bath at a constant temperature of 50° C. for 3 minutes, and then uses a rotary decompression concentrator to dry the solvent, so that a lipid film is formed on a bottle wall of the round-bottom flask, and an amount of 4 mL of potassium chloride electrolyte buffer solution (including the following seven types of buffer solution: pH 7.4/45 mM, pH 7.4/50 mM, pH 7.4/55 mM, pH 7.4/60 mM, pH 6.4/50 mM, pH 6.8/50 mM, and pH 7.8/50 mM) is added to perform a hydration reaction, and the temperature is maintained at 50° C., so that the lipid film on the bottle wall is dissolved into the solution, and then the round-bottom flask is put into a water bath at 50° C. and an ultrasonic instrument of power 60 W for 20 minutes, so as to prepare the uncharged particle dispersed-phase solution with a particle concentration of 5 mM. The electrically uncharged nanoparticle 2 prepared by this preparation method has a high stability for more than 12 hours in a high salt environment, which has a great benefit to the application.

A quantity of 40 μL of the electrically uncharged nanoparticle 2 is put into an upper reservoir at the first opening 11 of the conical nanopore 1, and an additional positive potential bias (V>0) is now added to the lower reservoir disposed at the second opening 12 of the nanopore 1, and the system generates a background current (I₀) now. Since the uncharged particle 2 is almost neutral or electrically uncharged (ζₚ≈0), therefore the electrophoretic force acted onto the uncharged particle 2 is very weak and almost negligible. Now, only the reverse electroosmotic force provided by the negatively charged nanopore 1 is acted onto the uncharged particle 2 (which will hinder the uncharged particle 2 from entering into the nanopore 1 as shown in FIG. 1), so that no current change signal will be observed in the process now. A positive pressure field (ΔP>0) is applied to the whole current sensing system of the nanopore 1, and the uncharged particle 2 receives a positive pressure force in addition to the reverse electroosmotic force. When the positive pressure field is slowly increased to an extent sufficient to overcome the reverse electroosmotic force, the measured value of the forward action force is now a critical pressure value, and the uncharged particle will move towards the nanopore 1 to cause a detected current change signal as shown in FIG. 2.

Now, the resultant force acted on the uncharged particle 2 is almost zero, so that equation (1) may be revised as follows:

$$0 = \frac{{ɛζ}_{NP} E}{μ} + \frac{{Q}_{p 1}}{A} \qquad ( 2 )$$

Regardless of the conical pore system or cylindrical pore system, the local electric field intensity E and the critical positive pressure flow Qₚ₁ in the pore can be estimated by the following two equations:

$$\begin{matrix}E = \frac{V ( ab )}{[ d + 0.8 ( a + b ) ] {a}^{2}} & ( 3 ) \\ {Q}_{p 1} = \frac{Δ {P}_{c 1}}{[ \frac{8 μ d ( \frac{1}{{a}^{3}} - \frac{1}{{b}^{3}} )}{3 π ( b - a )} + 1.5 μ ( \frac{1}{{a}^{3}} + \frac{1}{{b}^{3}} ) ]} & ( 4 )\end{matrix}$$

Where, V is the positive potential bias applied to the system, and ΔP_{c1} is the critical positive pressure value detected and measured by the experiment.

Therefore, Equation (2) can be further derived as below:

$${ζ}_{NP} = - \frac{μ {Q}_{p 1}}{ɛ EA} \qquad ( 5 )$$

After ΔP_{c1} is measured at a fixed voltage V in an experiment, this value is substituted into Equations (3) and (4) to obtain the local electric field E and the critical positive pressure flow Qₚ₁ in the pore, and then these two data are substituted into Equation (5) to obtain the zeta potential (ζ_{NP}) of the nanopore.

If the nanopore 1 is made of a positively charged surface material, it will simply need to apply an additional negative potential bias (V<0) to a lower reservoir disposed at the second opening 12 of the nanopore 1, wherein the electrophoretic force of the uncharged particle 2 is very weak or almost negligible, so that only the reverse electroosmotic force provided by the positively charged nanopore 1 is remained to be act on the uncharged particle 2 (which will block the uncharged particle 2 from entering into the nanopore 1), so that no current change signal will be observed during the process now. After a positive pressure field (ΔP>0) is applied to the whole current sensing system of the nanopore 1, the uncharged particle 2 not just receives the reverse electroosmotic force only, but also receives a positive pressure. After the positive pressure field is slowly increased to an extent sufficient to overcome the reverse electroosmotic force, the measured value of the forward action force is a new critical pressure value (ΔP_{c1}) now, and the uncharged particle will move towards the nanopore 1 to detect the current change signal. The negative potential bias and positive critical pressure value are substituted into Equations (3) and (4) to obtain the local electric field E and the critical positive pressure flow Qₚ₁ in the pore, and then these two data are substituted into Equation (5) to obtain the zeta potential (ζ_{NP}) of the positively charged nanopore.

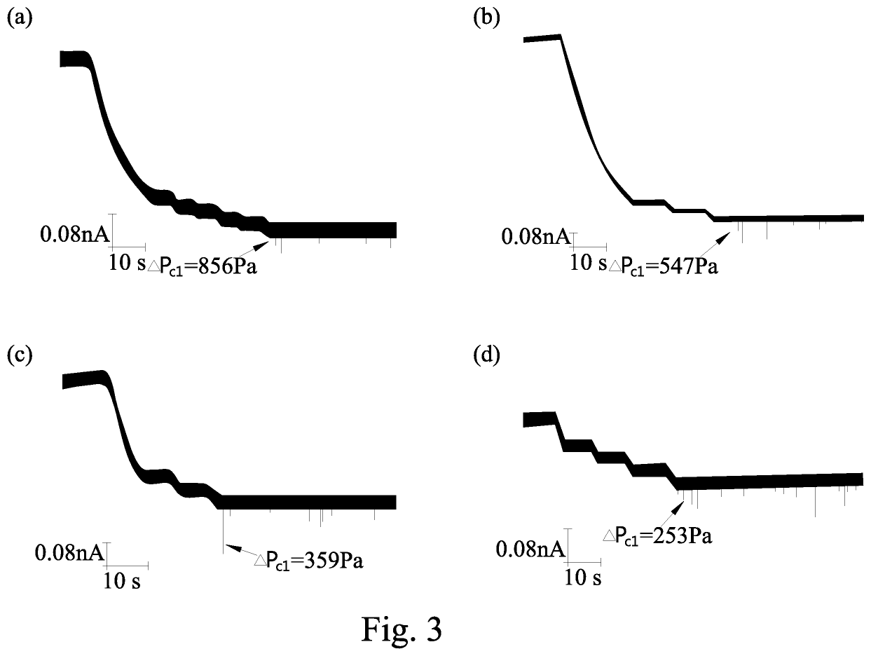

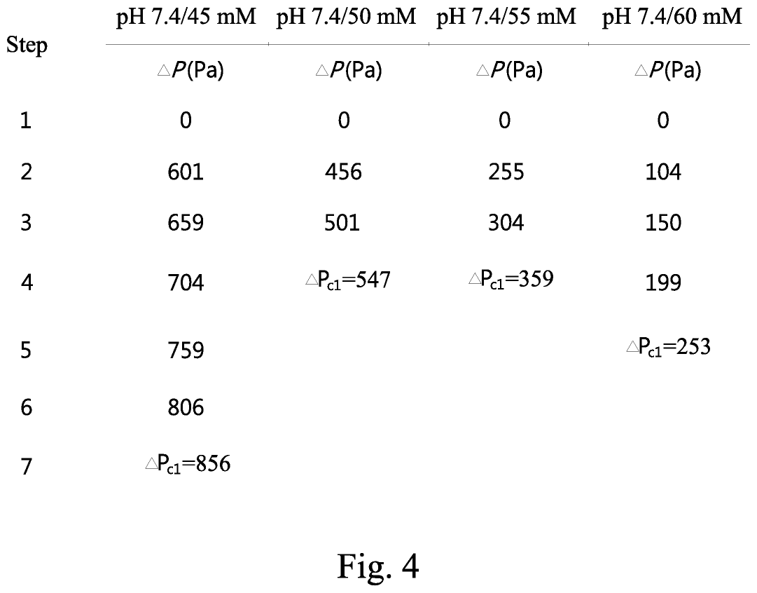

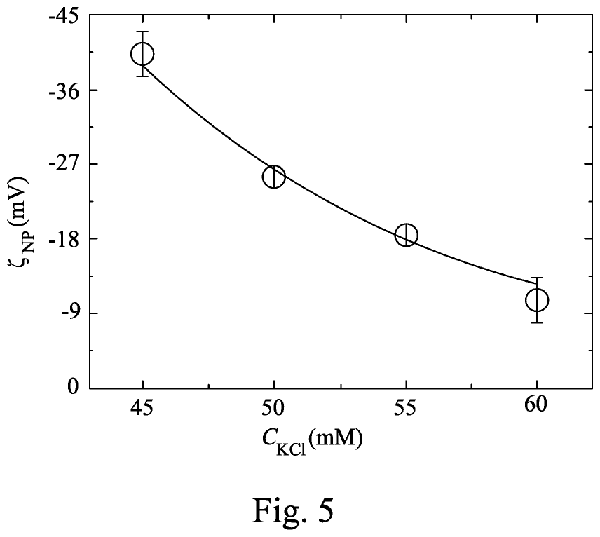

With reference to FIGS. 3 to 8, after the zeta potential of the nanopore 1 is measured, a change of the zeta potential of the nanopore can be analyzed in different environmental conditions of the electrolyte solution. Firstly, the effect of the electrolyte concentration on the zeta potential of the nanopore 1 is studied. The pH 7.4 is fixed while the KCl electrolyte concentration is changed to 45, 50, 55, and 60 mM for experiments, and the change of the zeta potential of the pore at different background electrolyte concentrations is measured. Firstly, the dispersed-phase solution of the uncharged particle 2 is placed into an upper reservoir disposed at the first opening 11 of the pore 1, and a positive potential bias is applied to a lower reservoir disposed at a second opening 12 of the pore 1. Now, a horizontal background ionic current will be generated as shown in FIG. 3, and we can observe that there is no current change signal in the horizontal background ionic current at the beginning, and it shows that the uncharged particle 2 has not received any additional electrophoretic force in order to drive it entering into nanopore 1. Once again, it shows that the zeta potential of the uncharged particle 2 is zero. Now, a forward pressure is slowly and gradually applied to the upper reservoir disposed at the first opening 11 of the pore 1, and a time duration of approximately 8-10 seconds is waited for each time before the pressure is applied. Until the downward pressure is slightly greater than the upward reverse electroosmotic force formed on a pore wall, the forward pressure leads the force receiving direction of the particle 2, so that the particle 2 will start entering into the pore 1 to generate a current change signal, and the uncharged particle 2 receives the drive from the forward pressure, and the pressure passing through the nanopore 1 is called the critical positive pressure value, and then the critical pressure value is recorded as shown in FIG. 4 and substituted into Equations (4) and (5) to measure the zeta potential of the nanopore in different KCl electrolyte concentrations C_{KCl}. The analyzed results are listed in FIG. 5, wherein the zeta potential ζ_{NP} of the nanopore 1 is plotted with respect to various KCl electrolyte concentrations C_{KCl} and the experimental results indicate that the zeta potential ζ_{NP} of the nanopore 1 increments with the increase in electrolyte concentration, and the reason that inventor surmises is as the electrolyte concentration increases, the thickness of the electric double layer on the charged pore wall decreases, and thus more counterions are attached closely onto the wall of the charged pore to produce a neutralization of the electrically charged pore wall, and thus resulting in a decremental tendency of the zeta potential of the nanopore 1, and this phenomenon is a typical behavior.

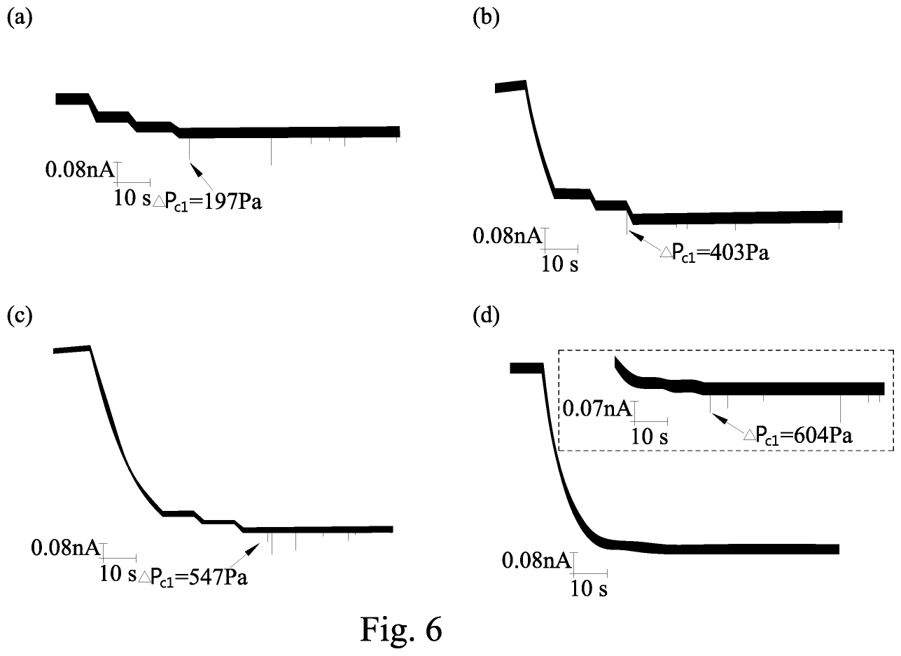

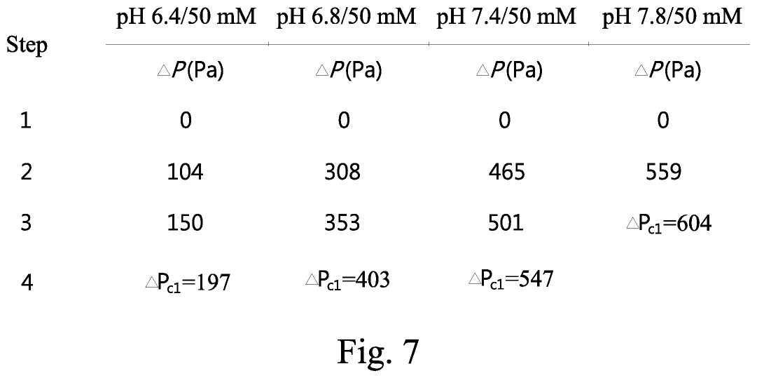

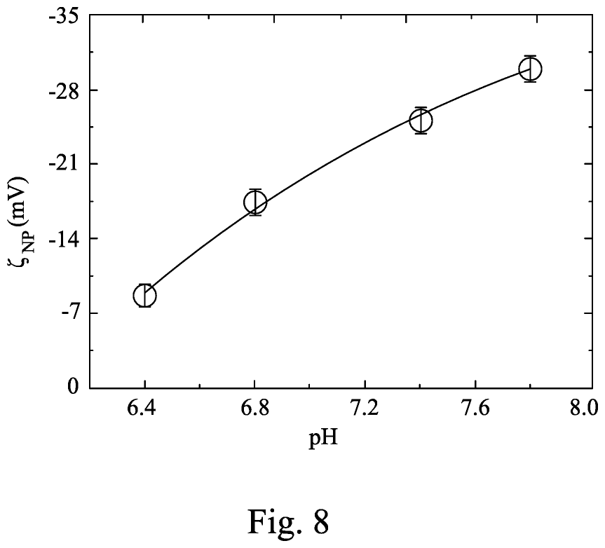

The effect of the nanopore 1 at different pH values of the solution is studied. With a fixed KCl electrolyte concentration of 50 mM, the pH values of the solution such as pH 6.4, 6.8, 7.4, and 7.8 are used in an experiment to measure a change of the zeta potential of the nanopore at different pH values. Similarly, a dispersed-phase solution of the uncharged particle 2 is placed into an upper reservoir disposed at the first opening 11 of the pore 1, and a positive potential bias is applied to a lower reservoir disposed at the second opening 12 of the pore 1. Now, a horizontal background ionic current will be generated as shown in FIG. 6, and we can observe that there is no current change signal in the horizontal background ionic current at the beginning, and it shows that the uncharged particle 2 has not been affected by the additional electric field driving an electrophoretic force to enter into the pore 1. Once again, it shows that the zeta potential of the uncharged particle 2 is zero. Thereafter, a forward pressure is slowly and gradually applied to the upper reservoir outside the first opening 11 of the pore 1, and a time duration of 8-10 seconds is waited before each time of applying the pressure. When the downward pressure is slightly greater than the upward reverse electroosmotic force formed on a hole wall, the forward pressure leads the force receiving direction of the uncharged particle 2, so that the uncharged particle 2 will start entering into the pore 1 to generate the current change signal, and the uncharged particle 2 receives the drive of the forward pressure, and the pressure passing through the pore 1 is called a critical positive pressure, and the critical pressure value is recorded as shown in FIG. 7 and substituted into Equations (4) and (5) to derive the zeta potential of the nanopore 1 at different pH values. The analyzed results are listed in FIG. 8, wherein the zeta potential ζ_{NP} of the nanopore 1 is plotted with respect to various pH values. It is found that the zeta potential of the nanopore 1 increases with the increase in pH value, and the reason that inventor surmises is the demonstrative nanopore 1 is made of thermoplastic polyurethane. The greater the pH value, the less the number of H⁺ in the solution. This phenomenon induces the functional groups on the surface of the pore wall to be ionized, so as to increase the number of negative surface charges, and affect the electrically charged property of the surface of the nanopore 1. Therefore, the zeta potential of the nanopore 1 will increase with the pH value.

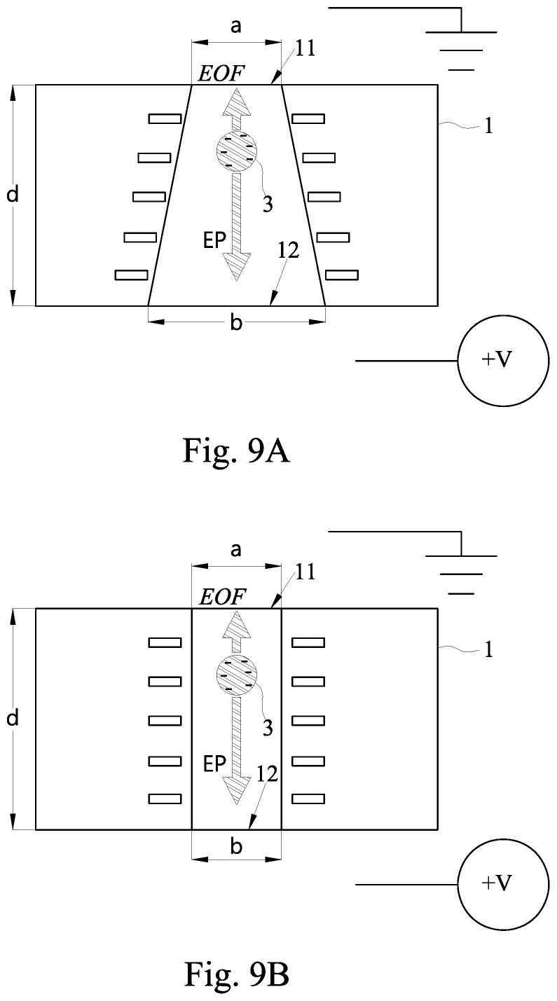

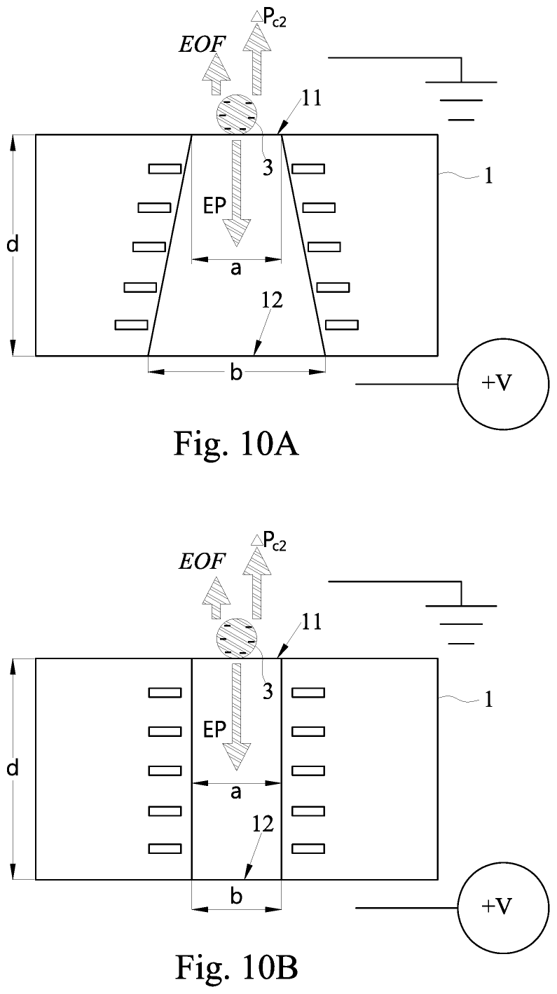

With reference to FIGS. 9 and 10 for a schematic view of particles and nanopores after a positive potential bias is applied in an experiment of detecting the zeta potential of charged nanoparticles and a schematic view of particles and pores after an additional negative pressure field is applied. The method for detecting the zeta potential of an electrically charged nanoparticle 3 in accordance with the present invention also uses the principle of electrokinetics of the resultant force of the particles in the nanopore together with the technique of detecting a current signal change for the measurement, and the previously measured zeta potential of the nanopore 1 is used for measuring the zeta potential of charged nanoparticles. In this embodiment, negatively charged nanoparticles are used in the experiment. Of course, positively charged particles may be used instead. Different electric charges give different electrokinetic directions in the experiment procedure, so that the detection method of this embodiment is similar to the aforementioned one. The method of this embodiment comprises the steps of: preparing at least a negatively charged nanoparticle 3 by dissolving hydrogenated soybean lecithin, oleic acid, and polyoxyethylene (40) stearate into a chloroform-methanol (v/v %=1/1) solvent; adding an amount of 2 mL molar ratio 4.5:4.5:1 of the solvent into a round-bottom flask in a thermostatic bath at a constant temperature of 50° C. for 3 minutes; drying the solvent, so that a lipid film is formed on a bottle wall of the round-bottom flask, and adding an amount of 4 mL of potassium chloride electrolyte buffer solution (including seven types: pH 7.4/45 mM, pH 7.4/50 mM, pH 7.4/55 mM, pH 7.4/60 mM, pH 6.4/50 mM, pH 6.8/50 mM, and pH 7.8/50 mM) to perform a hydration reaction, and the temperature is maintained at 50° C., so that the lipid film on the bottle wall is dissolved into the solution; placing the round-bottom flask into a water bath at 50° C. and an ultrasonic instrument of a power 60 W for 20 minutes, so as to prepare the dispersed-phase solution of the negatively charged nanoparticle 3 with a particle concentration of 5 mM.

An amount of 40 μL of the nanoparticle 3 is putted into an upper reservoir disposed at the first opening 11 of the conical nanopore 1, and a positive potential bias (V>0) is now applied to a lower reservoir disposed at the second opening 12 of the nanopore 1. Now, the system generates a background current (I₀). Since the nanoparticle 3 of this system is negatively charged, therefore the action forces exerted on the nanoparticle 3 further include a forward electrophoretic force as shown in FIG. 9 in addition to the reverse electroosmotic force (which will block the nanoparticle 3 from entering into the nanopore 1). Since the zeta potential of the nanoparticle 3 prepared by the method of the present invention is much greater than the zeta potential of the nanopore 1, therefore we can obviously observe a plurality of current change signals in an experiment. To prevent the nanoparticle 3 from passing through the nanopore 1 to achieve a force balance, a negative pressure field (ΔP<0) is applied to the whole current sensing experiment system. Now, the nanoparticle 3 will receive a reverse pressure action force to prevent the nanoparticle 3 from entering into the nanopore 1. When an additional negative pressure field is slowly added to an extent sufficient to overcome the resultant force of the forward electrophoretic force and the reverse electroosmotic force exerted onto the nanoparticle 3, the reverse action force is now a critical negative pressure value, and the nanoparticle 3 will not pass through the nanopore 1 anymore, so that no current change signal will be detected, and all resultant forces acted on the nanoparticle 3 are almost zero as shown in FIG. 10.

Now, the original Equation (1) may be modified to the following equation:

$$0 = - [ \frac{ɛ ( {ζ}_{p} - {ζ}_{NP} ) E}{μ} ] + \frac{{Q}_{p 2}}{A} \qquad ( 6 )$$

Wherein, the nanopore flow created by the additional negative pressure field may be calculated by the following equation:

$${Q}_{p 2} = \frac{Δ {P}_{c 2}}{[ \frac{8 μ d ( \frac{1}{{a}^{3}} - \frac{1}{{b}^{3}} )}{3 π ( b - a )} + 1.5 μ ( \frac{1}{{a}^{3}} + \frac{1}{{b}^{3}} ) ]} \qquad ( 7 )$$

In an experiment with a fixed voltage V, after ΔP_{c2} is measure, this value is substituted into Equations (3) and (7) to obtain a local electric field E and a critical negative pressure flow Qₚ₁ in the pore, and these two data and the ζ_{NP} obtained from the experiment of measuring the zeta potential of the nanopore 1 are substituted into Equation (6) to obtain the zeta potential (ζₚ) of the negatively charged nanoparticle 3 in the predetermined solution conditions.

If the whole experiment is carried out with the same conditions of the nanopore 1 and the same condition of applying the positive potential bias (in other words, the diameter (a) of the first opening 11, the diameter (b) of the second opening 12, the pore length (d), and the local electric field E in the nanopore 1 are the same), Equations (6) and equation (2) are shifted and divided to obtain the following equation:

$$\frac{{ζ}_{NP} - {ζ}_{p}}{{ζ}_{NP}} = \frac{Δ {P}_{c 2}}{Δ {P}_{c 1}} \qquad ( 8 )$$

The values of ΔP_{c1} and ζ_{NP} obtained by the previous experiment of measuring the zeta potential of the nanopore 1 and the value of ΔP_{c2} obtained in this experiment are substituted into Equation (8) to obtain the zeta potential (ζₚ) of the nanoparticle 3 at a predetermined solution condition.

In addition, the present invention also provides a method for detecting the zeta potential of positively charged nanoparticles by using the previous method of measuring the zeta potential of the nanopore 1, and the method comprises the steps of: preparing at least a positively charged nanoparticle, and placing the nanoparticle into a reservoir outside the first opening of a nanopore; applying a negative potential bias (V<0) to the nanopore, wherein the nanoparticle is positively charged, so that the nanoparticle will receive a forward electrophoretic force and a forward electroosmotic force provided by the negatively charged nanopore due to the negative potential bias, and the resultant force of both forward electrophoretic force and forward electroosmotic force are forward, so that the nanoparticle will move towards the interior of the nanopore, and the system current value has an obvious current signal change generated by the particles passing through the pore; applying a negative pressure field to the nanoparticle, so that the nanoparticle receives a reverse action force, and slowly increasing the negative pressure field, so that when the reverse action force is approximately equal to the resultant force of the forward electrophoretic force and the forward electroosmotic force, the positively charged nanoparticle will stop moving towards the interior of the nanopore, and the previous current change signal generated by the nanoparticle passing through the pore will not show up, and the measured value of the reverse action force is now a critical negative pressure value; calculating a critical negative pressure flow by the critical negative pressure value; and substituting all obtained values into

$$0 = - [ \frac{ɛ ( {ζ}_{p} - {ζ}_{NP} ) E}{μ} ] + \frac{{Q}_{p 3}}{A}$$

to calculate the zeta potential of the positively charged nanoparticle, where ζₚ is the zeta potential of the positively charged nanoparticle, ζ_{NP} is the zeta potential of the nanopore, μ is the viscosity of the solution, ε is the dielectric constant of the solution, Qₚ₁ is the critical negative pressure flow, E is the local field potential in the pore, and A is the area of the first opening of the nanopore,

The critical negative pressure flow Qₚ₃ is calculated by the following equation:

$${Q}_{p 3} = \frac{Δ {P}_{c 3}}{[ \frac{8 μ d ( \frac{1}{{a}^{3}} - \frac{1}{{b}^{3}} )}{3 π ( b - a )} + 1.5 μ ( \frac{1}{{a}^{3}} + \frac{1}{{b}^{3}} ) ]} \qquad ( 9 )$$

Where, ΔP_{c3} is the critical negative pressure value.

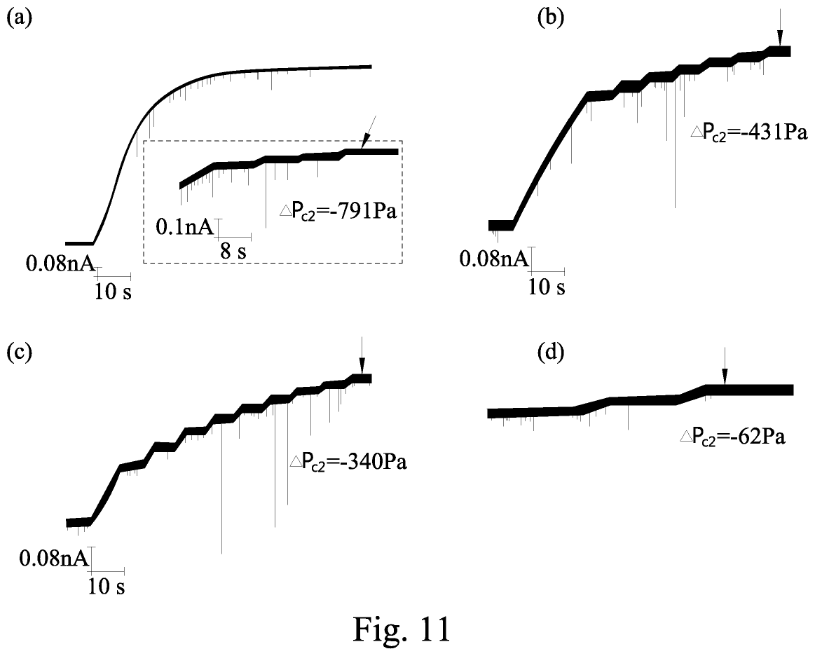

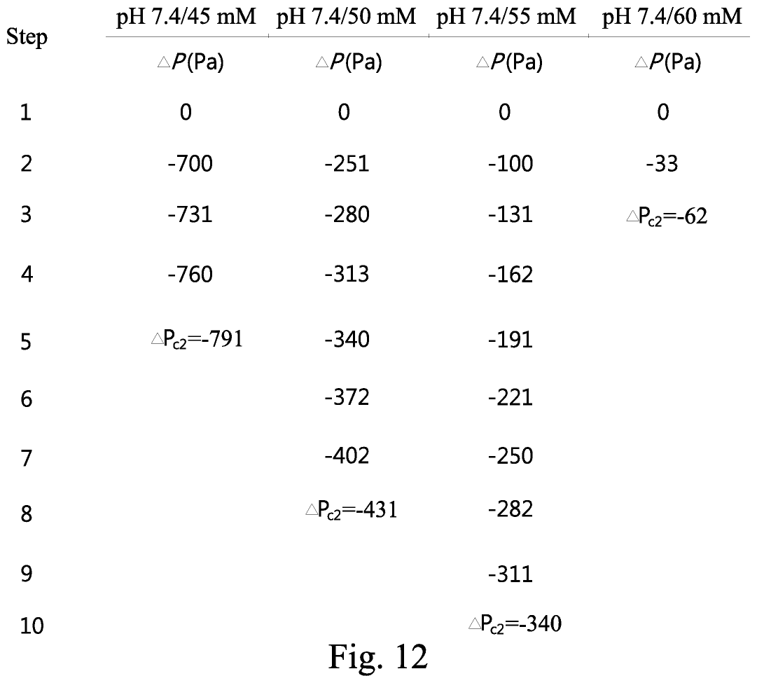

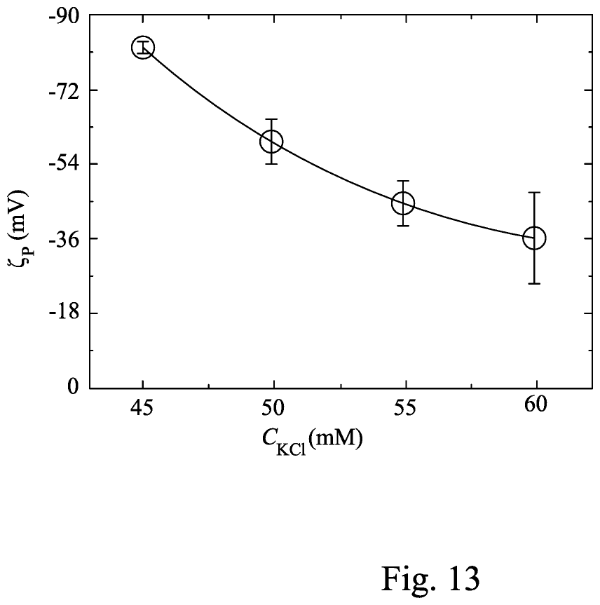

With reference to FIGS. 11 to 16, after the zeta potential of the negatively charged nanoparticle 3 is measured, a change of the zeta potential of nanoparticle can be analyzed in an environmental condition of an electrolyte solution. Firstly, the effect of the charged nanoparticle 3 in different background electrolyte concentrations is studied. While the pH 7.4 is fixed, the KCl electrolyte concentration is changed to 45, 50, 55, or 60 mM for an experiment of measuring a change of the zeta potential of the nanoparticle 3 at various electrolyte concentrations. Firstly, a dispersed-phase solution of the nanoparticle 3 is put into an upper reservoir disposed at the first opening 11 of the pore 1, and a positive potential bias is applied into a lower reservoir disposed at the second opening 12 of the pore 1 as shown in FIG. 11. Now, we can observe that many current change signals (current blockages) are generated within the horizontal background ionic current spectrum, and it shows that the nanoparticle 3 without being driven by any pressure can rely on its own electrophoretic force driven by the additional electric field to overcome the electroosmotic force on the hole wall from entering into the pore 1. A reverse negative pressure field is then applied slowly and gradually to an upper reservoir disposed at the first opening 11 of the pore 1, and a time duration of 8˜10 seconds is waited each time before the pressure is applied. Until the resultant force of the upward pressure action force and the electroosmotic force is precisely equal to the downward electrophoretic force to achieve a force balance, so that the whole resultant force acted on the nanoparticle 3 is zero, and the nanoparticle 3 will not pass through the pore 1 to generate a current change signal, and the reverse pressure of the particles 3 that stops passing through the pore 1 is called a critical negative pressure value, and the critical negative pressure value is recorded as shown in FIG. 12 and substituted into Equations (6) or (8) to determine the zeta potential of the nanoparticle 3 at different KCl electrolyte concentrations C_{KCl}. The analyzed results are listed in FIG. 13, and the zeta potential ζₚ of the nanoparticle 3 is plotted with respect to various KCl electrolyte concentrations C_{KCl}, and the experimental results show that if the KCl electrolyte concentration increases, the electric double layer thickness on the surface of the nanoparticle 3 will become thinner, and more counterions will be attracted, and a portion of the electric charges on the surface of the nanoparticle 3 will be neutralized to cause a smaller reverse critical negative pressure value required to pull up the nanoparticle 3 from the pore. Therefore, the zeta potential of the nanoparticle 3 will drop when the electrolyte concentration increases.

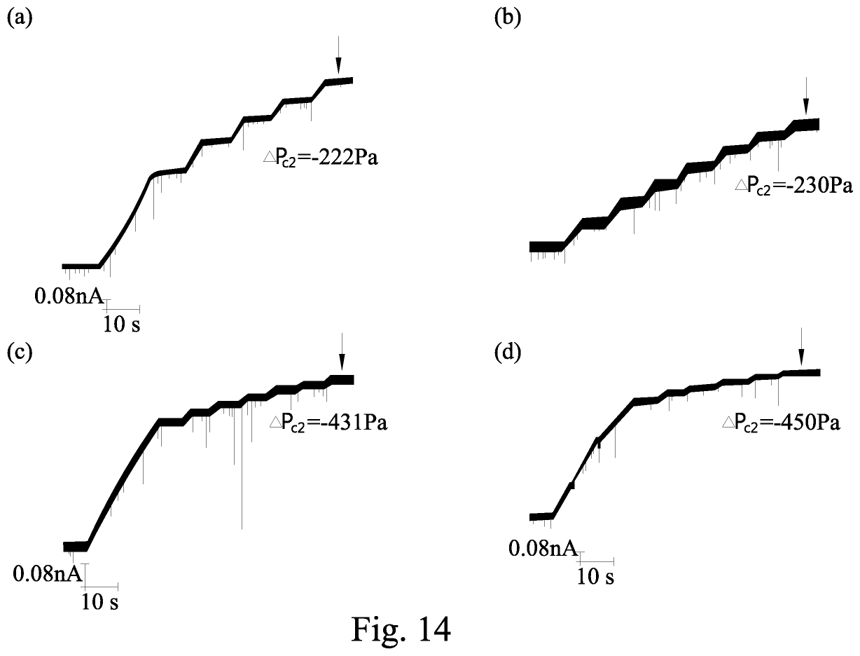

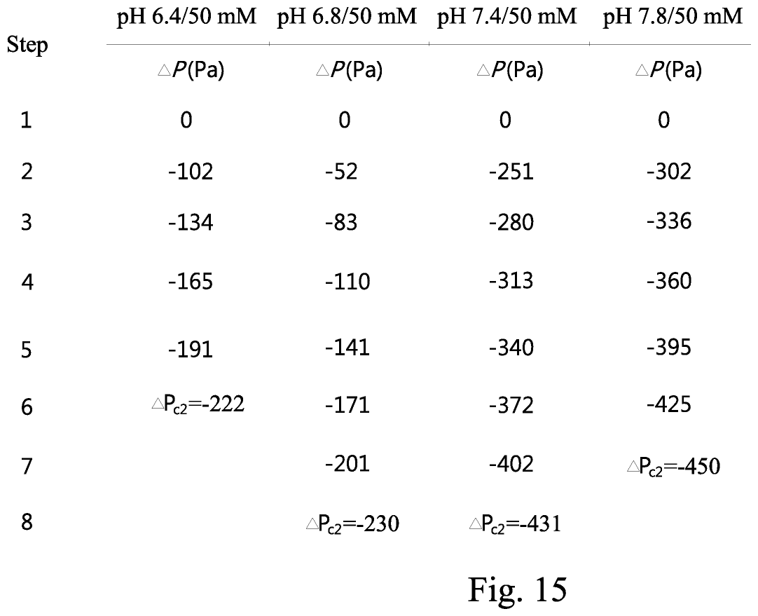

The effect of the nanoparticle 3 at different solution pH values is studied. When the KCl electrolyte concentration is fixed to 50 mM, and the pH value of the solution is changed to pH 6.4, 6.8, 7.4, or 7.8 for an experiment, and a change of the nanoparticle 3 at different pH values is measured. Similarly, a dispersed-phase solution of the nanoparticle 3 is placed into an upper reservoir disposed at the first opening 11 of the pore 1, and a positive potential bias is applied to the lower reservoir disposed at the second opening 12 of the pore 1 as shown in FIG. 14. Now, we can observe that there is many current change signals (current blockages) generated within the horizontal background ionic current spectrum, and it shows that the nanoparticle 3 without being driven by a pressure can rely on its own electrophoretic force driven by an additional electric field to overcome the electroosmotic force on the hole wall from entering into the pore 1. A reverse negative pressure field is then applied slowly and gradually to an upper reservoir disposed at the first opening 11 of the pore 1, and a time duration of 8˜10 seconds is waited each time before the pressure is applied. Until the resultant force of the upward pressure action force and the electroosmotic force is precisely equal to the downward electrophoretic force to achieve a force equilibrium, so that the whole resultant force acted on the nanoparticle 3 is zero, and the nanoparticle 3 will not pass through the pore 1 to generate a current change signal, and the reverse pressure of the particles 3 that stops passing through the pore 1 is called a critical negative pressure value, and the critical negative pressure value is recorded as shown in FIG. 15 and substituted into Equations (6) or (8) to determine the zeta potential of the nanoparticle 3 at various pH values.

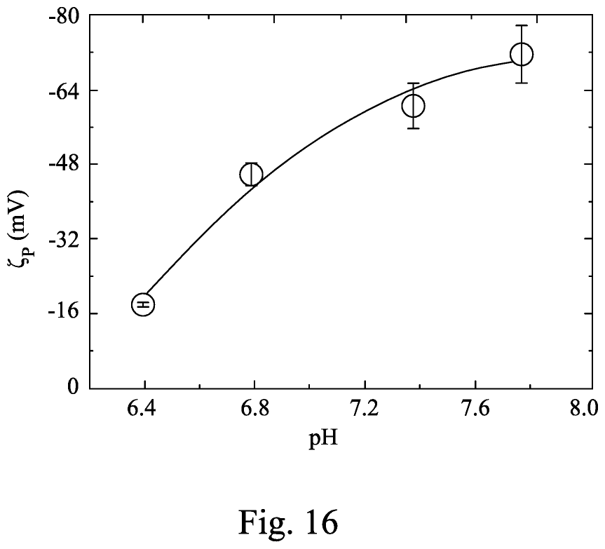

The analyzed results are listed in FIG. 16, and the zeta potential of the nanoparticle 3 is plotted with respect to various pH values, and the experimental results show that the negative zeta potential of the nanoparticle 3 increases with the pH value, and the reason that inventor surmises is the carboxylic acid group of the oleic acid of the nanoparticle 3 is ionized, and an increase of the pH value will affect the ionization level of the particles 3, so as to affect the extent of the electrically charged surface. As a result, the surface has more negative charges, and thus the zeta potential of the nanoparticle will rise accordingly, and such tendency of the zeta potential of the nanoparticle 3 matches with the dynamic light scattering (DLS).

This invention adopts principle of electrokinetics of the resultant force of particles in the nanopore together with the technique of detecting the current signal change for the conditions of different KCl electrolyte solution concentrations and pH values. This disclosure achieves the effect of detecting the zeta potential of the electrically charged nanoparticle 3 in a high electrolyte concentration environment, and the detected nanoparticle 3 has a maximum zeta potential falling at −80 mV. In most literatures, an oleic acid is added as a pH sensitive nanoparticle 3, and its zeta potential value falls within a range of −50˜−80 mV.

In summation of the description above, the present invention provides a novel method to measure the zeta potentials of the nanopore 1 and the nanoparticle 3 and also explores the changes of the zeta potentials of the nanopore 1 and nanoparticle 3 at different solution properties (such as different pH values and different electrolyte concentrations). According to the experimental results, the zeta potentials of the nanopore 1 and nanoparticle 3 is correlated with the pH value. The greater the pH value of the solution, the greater the negative zeta potentials. In addition the greater the background salt concentration, the lower the negative zeta potentials of the nanopore 1 and electrically charged nanoparticle 3. According to the aforementioned reasonable and successful measurement, we know that the measuring method of the present invention has a very high potential and the method can directly and accurately measure an zeta potential changes of the nanopore 1 and nanoparticle 3 in a high electrolyte concentration environment without requiring detailed spectrum for analyzing the current blockage signals or requiring the purchase of expensive standard item particles, so that this invention has the effect of simplifying the measurement process and lowering the measurement cost significantly. For soft nanoparticles, this invention can sense the zeta potential of particles more accurately to improve the value of the method disclosed in this invention.

What is claimed is:

1. A method for detecting an zeta potential of nanopores, comprising the steps of:
preparing at least a uncharged particle, and placing the uncharged particle at an upper reservoir disposed at a position outside a first opening of a nanopore;
applying a positive potential bias (V>0) to the nanopore, wherein the uncharged particle is neutral, so that the uncharged particle only receives a reverse electroosmotic force provided by a negatively charged nanopore due to the positive potential bias, and the uncharged particle cannot enter into the nanopore, and a system current signal now is a pure background ionic current;
applying a positive pressure field (ΔP>0) to the uncharged particle, so that the uncharged particle receives a positive pressure, and slowly increasing the positive pressure field, so that when the positive pressure is approximately equal to the reverse electroosmotic force, the uncharged particle will start moving towards an interior of the nanopore to change the system current signal, wherein a measured value of the positive pressure is a critical positive pressure value;
calculating a critical pressure flow using the critical positive pressure value, and calculating an additional local electric field intensity using a value of the positive potential bias; and
using an equation of ζ_{NP}=−(μQₚ₁)/(εEA) to obtain the zeta potential of the nanopore, where ζ_{NP} is the zeta potential of the nanopore, μ is a viscosity of a solution, ε is a dielectric constant of the solution, Qₚ₁ is the critical pressure flow, E is a local electric field in the nanopore, and A is an area of the first opening of the nanopore.

2. The method of claim 1, wherein the critical pressure flow is calculated by
$${Q}_{p 1} = \frac{Δ {P}_{c 1}}{[ \frac{8 μ d ( \frac{1}{{a}^{3}} - \frac{1}{{b}^{3}} )}{3 π ( b - a )} + 1.5 μ ( \frac{1}{{a}^{3}} + \frac{1}{{b}^{3}} ) ]} , \qquad$$
where ΔP_{c1} is the critical positive pressure value, a is a first opening diameter of the nanopore, b is a second opening diameter of the nanopore, and d is a length of the nanopore.

3. The method of claim 2, wherein the local field potential is calculated by
$$E = \frac{V ( ab )}{[ d + 0.8 ( a + b ) ] {a}^{2}} ,$$
where V is the positive potential bias applied.

4. The method of claim 3, wherein the first opening diameter of the nanopore is calculated by a=(4dI₀)/(πΛVb), where Λ is an electric conductivity of an electrolyte solution, I₀ is the pure background ionic current of the nanopore measured at the condition of the electrolyte solution.

5. The method of claim 1, wherein the method of preparing the uncharged particle comprises the steps of:
dissolving hydrogen phosphatidylcholine and polyoxyethylene (40) stearate into a chloroform-methanol (v/v %=1/1) solvent, and adding the solvent into a round-bottom flask for a thermostatic bath at a constant-temperature;
drying the solvent, until a lipid film is formed on a bottle wall of the round-bottom flask;
respectively adding seven types of potassium chloride electrolyte buffer solutions to perform a hydration reaction, so that the lipid film formed on the bottle wall is dissolved into the solutions; and
placing the round-bottom flask into a constant-temperature water bath and a constant-power ultrasonic instrument for at least 20 minutes.

6. A method for detecting an zeta potential of nanopores, comprising the steps of:
preparing at least a uncharged particle, and placing the uncharged particle at an upper reservoir disposed at a position outside a first opening of a nanopore;
applying a negative potential bias (V<0) to the nanopore, wherein the uncharged particle is neutral, so that the uncharged particle only receives a reverse electroosmotic force provided by a positively charged nanopore due to the negative potential bias, and the uncharged particle cannot enter into the nanopore, and a system current signal now is a pure background ionic current;
applying a positive pressure field (ΔP>0) to the uncharged particle, so that the uncharged particle receives a positive pressure, and slowly increasing the positive pressure field, so that when the positive pressure is approximately equal to the reverse electroosmotic force, the uncharged particle will start moving towards an interior of the nanopore to change the system current signal, wherein a measured value of the positive pressure is a critical positive pressure value;
calculating a critical pressure flow using the critical positive pressure value, and calculating an additional local electric field intensity using a value of the positive potential bias; and
using an equation of ζ_{NP}=−(μQₚ₁)/(εEA) to obtain the zeta potential of the nanopore, where ζ_{NP} is the zeta potential of the nanopore, μ is a viscosity of a solution, ε is a dielectric constant of the solution, Qₚ₁ is the critical pressure flow, E is a local electric field in the nanopore, and A is an area of a first opening of the nanopore.

7. The method of claim 6, wherein the critical pressure flow is calculated by
$${Q}_{p 1} = \frac{Δ {P}_{c 1}}{[ \frac{8 μ d ( \frac{1}{{a}^{3}} - \frac{1}{{b}^{3}} )}{3 π ( b - a )} + 1.5 μ ( \frac{1}{{a}^{3}} + \frac{1}{{b}^{3}} ) ]} ,$$
and the local electric field is calculated by
$$E = \frac{V ( ab )}{[ d + 0.8 ( a + b ) ] {a}^{2}} ,$$
where V is the negative potential bias applied, ΔP_{c1} is the critical pressure value, a is a first opening diameter of the nanopore, b is a second opening diameter of the nanopore, and d is a length of the nanopore.

8. The method of claim 6, wherein the method of preparing the uncharged particle comprises the steps of:
dissolving hydrogen phosphatidylcholine and polyoxyethylene (40) stearate into a chloroform-methanol (v/v %=1/1) solvent, and adding the solvent into a round-bottom flask for a thermostatic bath at a constant-temperature;
drying the solvent, until a lipid film is formed on a bottle wall of the round-bottom flask;
respectively adding seven types of potassium chloride electrolyte buffer solutions to perform a hydration reaction, so that the lipid film formed on the bottle wall is dissolved into the solutions; and
placing the round-bottom flask into a constant-temperature water bath and a constant-power ultrasonic instrument for at least 20 minutes.

9. A method for detecting an zeta potential of nanoparticles using the method according to claim 1, comprising the steps of:
preparing at least a negatively charged nanoparticle, and placing the negatively charged nanoparticle into a reservoir outside the first opening of the nanopore;
applying a positive potential bias (V>0) to the nanopore, wherein the negatively charged nanoparticle is negatively charged, so that the negatively charged nanoparticle receive a reverse electroosmotic force and a forward electrophoretic force provided by a negatively charged nanopore due to a positive potential bias, and the forward electrophoretic force is greater than the reverse electroosmotic force, so that the negatively charged nanoparticle will move towards the interior of the nanopore, and a system current value will have an obvious current signal change produced by particles passing through the nanopore;
applying a negative pressure field to the negatively charged nanoparticle, such that the negatively charged nanoparticle receives a reverse action force, and slowly increasing the negative pressure field, so that when the reverse action force plus the reverse electroosmotic force is approximately equal to the forward electrophoretic force, the negatively charged nanoparticle will stop moving towards the interior of the nanopore, and the previous current change signal generated by the negatively charged nanoparticle passing through the nanopore will not show up, and now a measured value of the reverse action force is a critical negative pressure value; and
calculating an zeta potential of the negatively charged nanoparticle by using the equation of
$$\frac{{ζ}_{NP} - {ζ}_{p}}{{ζ}_{NP}} = \frac{Δ {P}_{c 2}}{Δ {P}_{c 1}} ,$$
where ζₚ is the zeta potential of the negatively charged nanoparticle, ζ_{NP} is the zeta potential of the nanopore, ΔP_{c2} is the critical negative pressure value, and ΔP_{c1} is the critical pressure value.

10. The method of claim 9, wherein the method of preparing the negatively charged nanoparticle comprises the steps of:
dissolving hydrogenated soybean lecithin, oleic acid, and polyoxyethylene (40) stearate into a chloroform-methanol (v/v %=1/1) solvent, and adding the chloroform-methanol solvent into a round-bottom flask for a thermostatic bath at a constant-temperature;
drying the solvent until a lipid film is formed on a bottle wall of the round-bottom flask;
respectively adding seven types of potassium chloride electrolyte buffer solutions to perform a hydration reaction, so that the lipid film formed on the bottle wall is dissolved into the solution; and
placing the round-bottom flask into a constant-temperature water bath and a constant-power ultrasonic instrument for at least 20 minutes.

11. A method of detecting Darticles using the method according to claim 1, comprising the steps of:
preparing at least a positively charged nanoparticle, and placing the positively charged nanoparticle into a reservoir outside the first opening of the nanopore;
applying a negative potential bias (V<0) to the nanopore, wherein the positively charged nanoparticle is positively charged, so that the positively charged nanoparticle receives a forward electrophoretic force due to the negative potential bias and a forward electroosmotic force provided by the negatively charged nanopore, and a resultant force of the forward electrophoretic force and the forward electroosmotic force is forward, so that the positively charged nanoparticle will move towards the interior of the nanopore, and a system current value shows an obvious current change signal generated by the particles passing through the nanopore;
applying a negative pressure field to the positively charged nanoparticle, so that the positively charged nanoparticle receives a reverse action force, and slowly increasing the negative pressure field, so that when the reverse action force is approximately equal to a resultant force of the forward electrophoretic force and the forward electroosmotic force, the positively charged nanoparticle will stop moving towards the interior of the nanopore, and a previous current change signal generated by the positively charged nanoparticle passing through the nanopore will not show up, and a measured value of the reverse action force is now a critical negative pressure value; and
calculating the zeta potential of the positively charged nanoparticle by using the equation of
$$- ( \frac{{ζ}_{NP} - {ζ}_{p}}{{ζ}_{NP}} ) = \frac{Δ {P}_{c 3}}{Δ {P}_{c 1}} ,$$
where ζₚ is the zeta potential of the positively charged nanoparticle, ζ_{NP} is the zeta potential of the nanopore, ΔP_{c3} is the critical negative pressure value, and ΔP_{c1} is a critical pressure value.
